(19) United States
(12) Patent Application Publication
(10) Pub. No.: US 2022/0122346 A1
(43) Pub. Date: Apr. 21, 2022

(54) METHOD AND APPARATUS FOR IDENTIFYING GAME AREA TYPE, ELECTRONIC DEVICE AND STORAGE MEDIUM

(71) Applicant: SENSETIME INTERNATIONAL PTE. LTD., Singapore (SG)

(72) Inventor: Chunya Liu, Singapore (SG)

(21) Appl. No.: 17/563,763

(22) Filed: Dec. 28, 2021

Related U.S. Application Data
(63) Continuation of application No. PCT/IB2021/062080, filed on Dec. 21, 2021.

(30) Foreign Application Priority Data
Dec. 17, 2021 (SG) 10202114021V

(51) Int. Cl. G06V 10/764; G06N 3/08; G06V 10/56; G06V 10/25; G06V 10/774; G06V 10/82

(52) U.S. Cl. CPC G06V 10/764; G06N 3/08; G06V 10/82; G06V 10/25; G06V 10/774; G06V 10/56

(57) ABSTRACT

Provided are a method and apparatus for identifying a game area type, an electronic device and a storage medium. The method includes: acquiring a first game area image to be identified; identifying the first game area image through a first branch network of a trained classification model to obtain a color classification result of a game area in the first game area image; identifying a second game area image through a second branch network of the trained classification model to obtain a layout classification result of the game area, the second game area image being a binary image obtained by performing image processing on the first game area image; and determining a target type of the game area based on the color classification result and the layout classification result of the game area.

### CROSS-REFERENCE TO RELATED APPLICATION(S)

The application is continuation of international patent application No. PCT/IB2021/062080, filed on 21 Dec. 2021, which claims priority to Singaporean patent application No. 10202114021V, filed with IPOS on 17 Dec. 2021. The contents of international patent application No. PCT/IB2021/062080 and Singaporean patent application No. 10202114021V are incorporated herein by reference in their entireties.

### TECHNICAL FIELD

The disclosure relates to the technical field of computer vision, and relates to, but not limited to, a method and apparatus for identifying a game area type, an electronic device and a storage medium.

### BACKGROUND

Image classification plays an important role in an intelligent video analysis system. In a game scenario, many game areas with different layouts are arranged. However, in game playing of different types of game areas, the object arranging areas and layouts, and even the game rules may be different.

In the related art, a corresponding system is manually deployed according to the type of each game area. According to the scheme, not only multiple versions of systems supporting different gambling area types are required to be maintained, but also manual inspection is required to ensure that each deployed system adapts to the corresponding game area type. Therefore, the manual deployment method has high system complexity and excessive consumption of human resources, and it is prone to wasting resources and costs due to a wrong deployment strategy.

### SUMMARY

The embodiments of the disclosure provide a method and apparatus for identifying a game area type, an electronic device and a storage medium.

The technical schemes of the embodiments of the disclosure are implemented in the following aspects.

In a first aspect, an embodiment of the disclosure provides a method for identifying a game area type, including the following operations

A first game area image to be identified is acquired.

The first game area image is identified through a first branch network of a trained classification model to obtain a color classification result of a game area in the first game area image.

A second game area image is identified through a second branch network of the trained classification model to obtain a layout classification result of the game area, the second game area image being a binary image obtained by performing image processing on the first game area image.

A target type of the game area is determined based on the color classification result and the layout classification result of the game area.

In some embodiments, a second game area image is obtained by the following steps: grayscale processing is performed on a first game area image to obtain a grayscale image corresponding to the first game area image; and performing binarization processing on the grayscale image to obtain the second game area image based on a grayscale value of each pixel in the grayscale image.

Therefore, the raw first game area image is converted into the grayscale image, then, binarization processing is performed on the grayscale image based on the grayscale value of each pixel in the grayscale image, the second game area image is obtained, so that color information of the first game area image to be identified is removed, and a binary black-and-white image including only layout information of a game area is obtained as the second game area image, which facilitates a classification model to identify a layout classification result of the game area.

In some embodiments, the operation of performing grayscale processing on a first game area image to obtain a grayscale image corresponding to the first game area image includes: determining a weight coefficient of each color channel of each pixel in the first game area image based on identification and classification requirement of a game area; and determining a grayscale value of each pixel in the grayscale image based on a pixel value and the corresponding weight coefficient of each color channel of each pixel in the first game area image.

Therefore, the weight of the color channel related to the background is correspondingly reduced when the grayscale value of each pixel in the grayscale image is calculated according to the identification and classification requirement of the game area, so that the background color is removed more thoroughly and the layout information of the game area may be highlighted better.

In some embodiments, the operation of performing binarization processing on a grayscale image based on a grayscale value of each pixel in the grayscale image to obtain a second game area image includes: a target pixel value of each pixel is determined by sequentially comparing the grayscale value of each pixel with a specific threshold value, and the target pixel value being a pixel value corresponding to black or white; and obtaining the second game area image based on target pixel values of all pixels in the grayscale image.

Therefore, each pixel in the grayscale image is converted into black or white to obtain the second game area image based on the comparison result between the grayscale value of each pixel in the grayscale image and the specific threshold value. Therefore, the second game area image is a binary black-and-white image, and the color related to the background is removed, and only the layout information is retained.

In some embodiments, the method further includes: a target area in a second game area image is determined; and a background mask is added to the target area in the second game area image to obtain a new second game area image.

Therefore, the target area without obvious layout information in the second game area image is directly covered with the background mask, which may accelerate identifying the layout information of the second game area image by a classification model and improve the identification efficiency and accuracy.

In some embodiments, a classification model is trained by the following steps: a training sample set is acquired, which includes at least two training samples, annotated types of which are not exactly the same; iterative training is performed on a classification model by utilizing the training sample set; a target loss of the classification model is determined based on the annotated type of each training sample in the training sample set in each iteration; and a trained classification model is obtained when the target loss of the classification model meets a preset convergence condition.

Therefore, the classification model is trained by utilizing multiple training samples, the annotated types of which are not exactly the same, and the target loss is determined based on the corresponding annotated type, so that the two factors of background color and area layout are fully taken into consideration in the training of the classification model, thereby improving the accuracy of identifying a game area type.

In some embodiments, the annotated type of each training sample includes a first tag value corresponding to a color type and a second tag value corresponding to a layout type, and the operation of determining a target loss of a classification model based on the annotated type of each training sample in a training sample set in each iteration includes: a first loss corresponding to a first branch network is determined based on the first tag value and a color classification result of each training sample output through the first branch network in each iteration; a second loss corresponding to a second branch network is determined based on the second tag value and a layout classification result of each training sample output through the second branch network in each iteration; and the target loss of the classification model is determined based on the first loss and the second loss.

Therefore, the loss of each of the two branch networks are respectively calculated through the first tag value corresponding to the color type and the second tag value corresponding to the layout type, and then the final optimized target loss of the whole classification model is obtained, so that a classification network with both the area color and the area layout taken into consideration may be trained based on the target loss.

In some embodiments, the method further includes: image processing is performed on each training sample in a training sample set to obtain a binary image set; and accordingly, the operation of performing iterative training on a classification model by utilizing the training sample set, includes iterative training is performed on a first branch network of the classification model by utilizing the training sample set; and iterative training is performed on a second branch network of the classification model by utilizing the binary image set.

Therefore, the training sample set and the corresponding binary image set are configured to respectively train two branch networks of the classification model, so that the trained classification model may simultaneously identify a color classification result and a layout classification result of a game area, and the identification accuracy is improved.

In some embodiments, each of first branch network and second branch network includes a backbone network layer, a fully connected layer, and a softmax layer.

Therefore, by constructing two branch networks with each including a structure of the backbone network layer, fully connected layer and softmax layer, a formed classification network may obtain classification results with two factors taken into consideration simultaneously, and reduce the costs of manual inspection and identification errors.

In a second aspect, an embodiment of the disclosure provides an apparatus for identifying a game area type, including a first acquisition module, a first identification module, a second identification module and a first determination module.

The first acquisition module is configured to acquire a first game area image to be identified.

The first identification module is configured to identify the first game area image through a first branch network of a trained classification model to obtain a color classification result of a game area in the first game area image.

The second identification module is configured to identify a second game area image through a second branch network of the trained classification model to obtain a layout classification result of the game area. The second game area image is a binary image obtained by performing image processing on the first game area image.

The first determination module is configured to determine a target type of the game area based on the color classification result and the layout classification result of the game area.

In a third aspect, an embodiment of the disclosure provides an electronic device, including a memory and a processor. The memory is configured to store a computer program executable by the processor, and the processor implements steps of the method for identifying a game area type when the program is executed by the processor.

In a fourth aspect, an embodiment of the disclosure provides a computer-readable storage medium. The computer-readable storage medium is configured to store a computer program, and when the program is executed by a processor, steps of the method for identifying a game area type are implemented.

The technical schemes of the embodiments of the disclosure at least have the following advantages that:

In the embodiments of the disclosure, firstly, a first game area image to be identified is acquired; then the first game area image is identified through a first branch network of a trained classification model to obtain a color classification result of a game area in the first game area image; a second game area image is identified through a second branch network of the trained classification model to obtain a layout classification result of the game area; and the second game area image is a binary image obtained by performing image processing on the first game area image; and finally, a target type of the game area is determined based on the color classification result and the layout classification result of the game area; and therefore, the background color information and layout information of the game area in the first game area image are simultaneously identified by the pre-trained classification model, so that the accuracy of identifying the game area type is improved, and the costs of manual inspection and identification errors are reduced.

### BRIEF DESCRIPTION OF THE DRAWINGS

In order to illustrate the technical schemes of the embodiments of the disclosure more clearly, the drawings required for the description of the embodiments will be briefly described below. It is apparent that the drawings described below are merely used to illustrate some embodiments of the disclosure, from which other drawings may be derived without inventive efforts by those of ordinary skill in the art.

FIG. 1 illustrates a flow diagram of a method for identifying a game area type according to an embodiment of the disclosure;

FIG. 2 illustrates a flow diagram of a method for identifying a game area type according to an embodiment of the disclosure;

FIG. 3 illustrates a flow diagram of determination of a second game area image according to an embodiment of the disclosure;

FIG. 4 illustrates a flow diagram of a method for training a classification model according to an embodiment of the disclosure;

FIG. 5 illustrates a flow diagram of a method for training a classification model according to an embodiment of the disclosure;

FIG. 6A is a logic flow diagram of a method for identifying a game area type according to an embodiment of the disclosure;

FIG. 6B illustrates a top view of a game area according to an embodiment of the disclosure;

FIG. 6C illustrates a top view of another game area according to an embodiment of the disclosure;

FIG. 7 illustrates a system block diagram of training of a classification model according to an embodiment of the disclosure;

FIG. 8 illustrates a schematic diagram of component structure of an apparatus for identifying a game area type according to an embodiment of the disclosure; and

FIG. 9 illustrates a schematic diagram of hardware entities of an electronic device according to an embodiment of the disclosure.

### DETAILED DESCRIPTION

In order to make the objectives, technical schemes and advantages of the embodiments of the disclosure to be understood clearly, the technical schemes of the embodiments of the disclosure will be clearly and comprehensively described below with reference to the drawings of the embodiments of the disclosure. It is apparent that the described embodiments are part and not all of the embodiments of the disclosure. The following embodiments are merely used to illustrate the disclosure, but are not intended to limit the scope of the disclosure. All other embodiments, which may be derived by those skilled in the art from the embodiments of the disclosure without making any inventive efforts, should fall within the scope of the disclosure.

In the following description, the term “some embodiments” describes a subset of all possible embodiments, and it should be understood that “some embodiments” may be same subsets or different subsets of all possible embodiments, which may be combined with each other on a non-conflict basis.

It should be noted that, the terms “first/second/third” in the description of the embodiments of the disclosure are merely used to distinguish similar objects, and are not intended to represent any specific sequencing of the objects. It should be understood that, if possible, the terms “first/second/third” may be interchanged in a specific order or sequence to enable the embodiments of the disclosure described herein to be implemented in an order other than that illustrated or described herein.

It should be understood that, unless otherwise defined, all terms (including technical and scientific terms) used herein have the same meaning as commonly understood by those skilled in the art to which the disclosure belongs. It should be further understood that terms, such as those defined in commonly used dictionaries, should be interpreted as having a meaning that is consistent with the meaning in the context of the relevant art and will not be interpreted in an idealized or overly formal sense, unless expressly so defined herein.

Consoles of different game area types are suitable for different games, therefore in the related art, corresponding systems are manually deployed according to the game area types in each console. With the increase of game area types, the disadvantages of the strategy has become increasingly prominent. The deployment requires manual confirmation on the versions of the systems. On the one hand, different versions of systems supporting multiple game area types are required to be maintained, and on the other hand, the labor costs of the deployment are increased.

Existing schemes of feature point matching or simple neural network classification have some characteristics in practical use that: the scheme of the feature point matching is sensitive to the layout of game areas, but overlooks the color information of the background thereof, and have poor discrimination in different colors of the same layout; and the scheme of simple classification network is sensitive to the color information of game areas, but it is prone to overlooking the layout details, which leads to poor discrimination in game areas with different layouts and the same color. Therefore, the two kinds of schemes cannot distinguish the color and layout information of background well, and robustness thereof is poor, and classification errors and system deployment failures are prone to being caused.

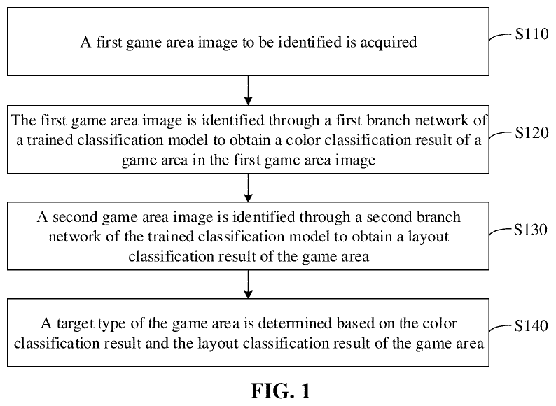

FIG. 1 illustrates a flow diagram of a method for identifying a game area type according to an embodiment of the disclosure. As shown in FIG. 1, the method includes at least the following steps.

At S110, a first game area image to be identified is acquired.

Here, the first game area image is an image including a game playing area, such as an image collected for a game table. A game may be a card game such as baccarat or a non-card game. It should be noted that multiple sub-areas may be arranged in the game playing area, in which game props, game coins, game indicators, etc. are arranged respectively.

It should be noted that, camera assemblies arranged in different directions of a game area may be utilized to shoot the video of the game area in real time, and the shot video may be sent to an edge device. Therefore, the edge device may capture images from the received video, and then sample to obtain the first game area image to be identified.

At S120, the first game area image is identified through a first branch network of a trained classification model to obtain a color classification result of a game area in the first game area image.

Here, the classification model is obtained based on training of training sample images of different game area types and a binary image for each of the training sample images after image processing.

The first game area image is a collected raw image, including area background color information and layout information of the game area. The first game area image is directly input to the first branch network of the classification model for identification, and then the color classification result of the game area in the first game area image may be output.

Illustratively, the color classification result of the game area may be red, green, gray, etc., and may be tagged as type A1, type A2, and type A3 respectively.

At S130, a second game area image is identified through a second branch network of the trained classification model to obtain a layout classification result of the game area.

Here, the second game area image is a binary image obtained by performing image processing on the first game area image. That is, the second game area image is a binary black-and-white image, in which the color-related background is removed, and only layout information is retained. The second game area image is directly input to the second branch network of the classification model for identification, and then the layout classification result of the second game area image may be output.

Illustratively, the layout classification result of the game area may be a large area type, a medium area type, a small area type, etc., and may be tagged as type B1, type B2 and type B3 respectively.

It should be noted that, image binarization refers to the process of setting a grayscale value of each pixel of an image to be 0 or 255, i.e., the whole image is obviously presented as black and white. That is, a grayscale image with 256 grayscales is processed by selecting an appropriate threshold to obtain a binary image which may further reflect the overall and local features of the image.

At S140, a target type of the game area is determined based on the color classification result and the layout classification result of the game area.

Here, the color classification result and the layout classification result of the game area are combined to obtain the target type of the game area, i.e., the target type includes both color type and layout type. For example, when the color classification result of the game area identified in the classification model is red (type A1) and the layout classification result is the medium area type (type B2), the output target type of the game area may be A1B2.

In the embodiment of the disclosure, the first game area image to be identified is acquired; then the first game area image is identified through the first branch network of the trained classification model to obtain the color classification result of the game area in the first game area image; the second game area image is identified through the second branch network of the trained classification model to obtain the layout classification result of the game area, and the second game area image is the binary image obtained by performing image processing on the first game area image; and finally, the target type of the game area is determined based on the color classification result and the layout classification result of the game area. Therefore, the background color information and layout information of the game area in the first game area image are simultaneously identified by the pre-trained classification model, so that the accuracy of identifying the game area type is improved, and the costs of manual inspection and identification errors are reduced.

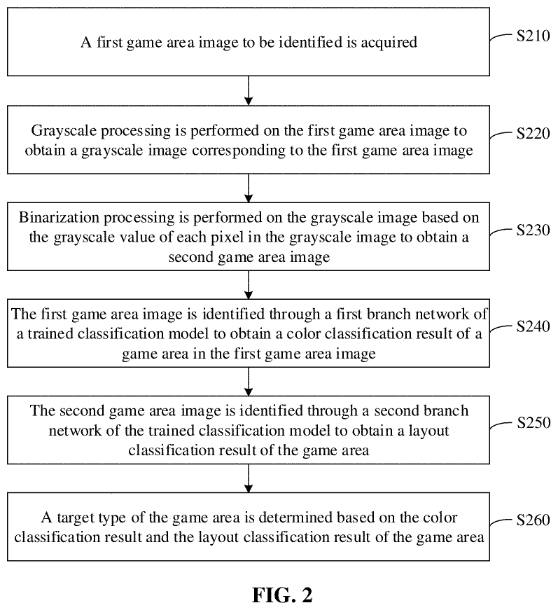

FIG. 2 illustrates a flow diagram of a method for identifying a game area type according to an embodiment of the disclosure. As shown in FIG. 2, the method includes at least the following steps.

At S210, a first game area image to be identified is acquired.

At S220, grayscale processing is performed on the first game area image to obtain a grayscale image corresponding to the first game area image.

Here, a grayscale value of each pixel in the first game area image is determined, and then the grayscale image corresponding to the first game area image may be obtained.

In some embodiments, pixel values of three color channels of each pixel are summed and then averaged to obtain a grayscale value of each pixel. In some other embodiments, a grayscale value of each pixel is obtained by performing grayscale weighting on pixel values of three color channels. The method for calculating the grayscale of each pixel is not limited here.

At S230, binarization processing is performed on the grayscale image based on the grayscale value of each pixel in the grayscale image to obtain a second game area image.

Here, when the method is implemented, a fixed threshold value may be set, the grayscale value of each pixel in the grayscale image is compared with the fixed threshold value, and each pixel is set to be white or black based on the corresponding comparison result, thereby obtaining the second game area image.

It should be noted that, the process of determining the second game area image of the above steps S220 to S230 may be executed before a classification model is input, or may be directly deployed in the classification model, i.e., only the first game area image is input to the classification model, and the process of steps S220 to S230 is executed in the classification model, which is not limited here.

At S240, the first game area image is identified through a first branch network of a trained classification model to obtain a color classification result of a game area in the first game area image.

At S250, the second game area image is identified through a second branch network of the trained classification model to obtain a layout classification result of the game area.

Here, the second game area image is a binary image obtained by performing image processing on the first game area image.

At S260, a target type of the game area is determined based on the color classification result and the layout classification result of the game area.

According to the embodiment of that disclosure, the raw first game area image is converted into the grayscale image, and then, binarization processing is performed on the grayscale image based on the grayscale value of each pixel in the grayscale image, and the second game area image is obtained, so that color information of the first game area image to be identified is removed, and a binary black-and-white image including only layout information of the game area is obtained as the second game area image, therefore the second branch network of the classification model is facilitated to identify the layout classification result of the game area.

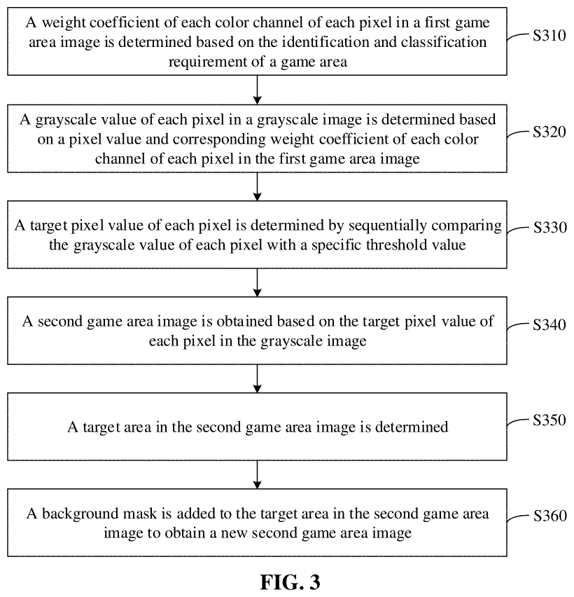

FIG. 3 illustrates a schematic flow diagram of determination of a second game area image according to an embodiment of the disclosure. As shown in FIG. 3, the process at least includes the following steps.

At S310, a weight coefficient of each color channel of each pixel in a first game area image is determined based on the identification and classification requirement of a game area.

Here, the identification and classification requirement may be identifying the layout of a specific game area to be identified, or identifying the layout of an area to be identified, in which players arrange game coins according to the business requirement.

It should be understood that, multiple functional areas are defined by different colors in the game area, such as an area in which players arrange game coins, an area in which bankers arrange game coins, and an area in which a game controller arranges game props. When the method is implemented, the areas are identified according to business requirement. In order to remove the background, when grayscale weighting is performed on each pixel, the weight corresponding to the boundary color of the corresponding area is reduced.

At S320, a grayscale value of each pixel in a grayscale image is determined based on a pixel value and corresponding weight coefficient of each color channel of each pixel in the first game area image.

Here, weighted summation is performed on the pixel values of all color channels of each pixel based on corresponding weight coefficients to obtain the grayscale value of each pixel in the first game area image in the grayscale image.

Illustratively, the calculation formula of the grayscale value of each pixel in the grayscale image may be: grayscale value=red weight coefficient*pixel value of red channel+green weight coefficient*pixel value of green channel+blue weight coefficient*pixel value of blue channel.

At S330, a target pixel value of each pixel is determined by sequentially comparing the grayscale value of each pixel with a specific threshold value.

Here, the target pixel value is a pixel value corresponding to black or white; and the pixel value corresponding to black is 0, and the pixel value corresponding to white is 255.

It should be understood that, each pixel, the grayscale of which is larger than or equal to a specific threshold is determined to belong to a specific object, otherwise the pixel is excluded from a specific object area, and the grayscale value is 0, representing that the pixel belongs to the background or another object area.

In some embodiments, when a grayscale value of each pixel is larger than or equal to a specific threshold value, it is determined that a target pixel value corresponding to the pixel is a pixel value corresponding to white. According to other embodiments, if a grayscale value of each pixel is smaller than a specific threshold value, it is determined that a target pixel value corresponding to the pixel is a pixel value corresponding to black.

At S340, a second game area image is obtained based on the target pixel value of each pixel in the grayscale image.

At S350, a target area in the second game area image is determined.

Here, the target area is an area without obvious layout information or an area without layout information related to the business requirement. For example, generally, the lower half of a game area includes at least one first area in which each game player arranges game coins, and the upper half includes a second area in which a game controller arranges game props. When the layout information of the at least one first area of the game area is required to be identified, the second area is set as a target area to be processed.

When the method is implemented, the target area in the second game area image may be determined based on a feature distribution and/or business requirement of the second game area image.

At S360, a background mask is added to the target area in the second game area image to obtain a new second game area image.

Here, the target area without obvious layout information in the second game area image is directly covered with the background mask, i.e., a pure color background, which may accelerate identifying the layout information of the second game area image by the classification model and improve the identification efficiency and accuracy.

In the embodiment of the disclosure, the weight of the color channel related to the background is correspondingly reduced when the grayscale value of each pixel in the grayscale image is calculated according to the identification and classification requirement of the game area, so that the background color is removed more thoroughly and the layout information of the game area may be highlighted better. Meanwhile, each pixel in the grayscale image is converted into black or white based on the comparison result between the grayscale value of each pixel in the grayscale image and the specific threshold value to obtain the second game area image. Therefore, the second game area image is a binary black-and-white image, and the color related to the background is removed, and only the layout information is retained.

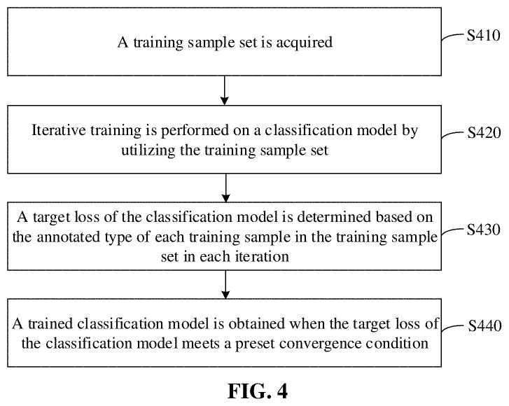

FIG. 4 illustrates a flow diagram of a method for training a classification model according to an embodiment of the disclosure. As shown in FIG. 4, the method at least includes the following steps.

At S410, a training sample set is acquired.

Here, the training sample set includes at least two training samples, the annotated types of which are not exactly the same. The annotated types include color-related types and layout-related types.

Illustratively, the annotated type of a first training sample includes color A1 and layout B1, and the annotated type of a second training sample includes color A1 and layout B2. The color types in the annotated types of the first training sample and the second training sample are the same and the layout types are different, i.e., the annotated types of the first training sample and the second training sample are not exactly the same.

At S420, iterative training is performed on a classification model by utilizing the training sample set.

Here, the training sample set is input into the classification model. After the model outputs a corresponding predicted classification result for each training sample, all the predicted classification results of the training sample set are input into the classification model again for iterative training.

At S430, a target loss of the classification model is determined based on the annotated type of each training sample in the training sample set in each iteration.

Here, the target loss of the classification model is determined based on the difference between the annotated type of each training sample and the corresponding predicted classification result output by the classification model.

At S440, a trained classification model is obtained when the target loss of the classification model meets a preset convergence condition.

Here, under the supervision of the target loss, the classification model is trained by utilizing the training sample set until the target loss meets the preset convergence condition, i.e., the parameters of the classification model are optimized, and the trained classification model is obtained.

In the embodiment of the disclosure, the classification model is trained by utilizing multiple training samples, the annotated types of which are not exactly the same, and the target loss is determined based on the annotated types, so that the two factors of background color and area layout are fully taken into consideration in the training of the classification model, thereby improving the accuracy of identifying the game area type.

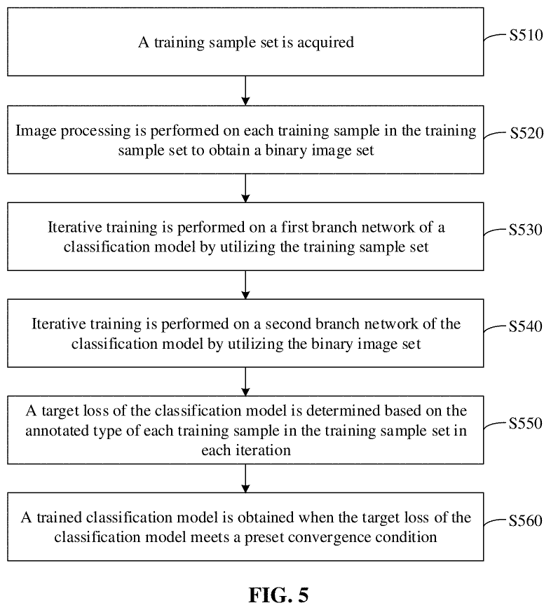

In some embodiments, an annotated type of each training sample includes a first tag value corresponding to a color type and a second tag value corresponding to a layout type. FIG. 5 illustrates a flow diagram of a method for training a classification model according to an embodiment of the disclosure. As shown in FIG. 5, the method at least includes the following steps.

At S510, a training sample set is acquired.

Here, the training sample set includes at least two training samples, annotated types of which are not exactly the same.

At S520, image processing is performed on each training sample in the training sample set to obtain a binary image set.

Here, a grayscale value of each pixel in each training sample of the training sample set is determined; then, a target pixel value of each pixel in each training sample is determined by sequentially comparing the grayscale value of each pixel with a specific threshold value; and finally, a binary image corresponding to the training sample is obtained based on the target pixel value of each pixel in each training sample.

At S530, iterative training is performed on a first branch network of a classification model by utilizing the training sample set.

Here, the training sample set is input to the first branch network of the classification model, and a first predicted result related to the color type in each training sample is output; and the first branch network of the classification model is iteratively optimized until convergence is reached based on the difference between the first predicted result and a first tag value.

At S540, iterative training is performed on a second branch network of the classification model by utilizing the binary image set.

Here, the binary image set is input to the second branch network of the classification model, and a second predicted result related to the layout type in each training sample is output; and the second branch network of the classification model is iteratively optimized until convergence is reached based on the difference between the second predicted result and a second tag value.

In some embodiments, each of first branch network and second branch network includes a backbone network layer, a fully connected layer and a softmax layer. A backbone network layer is configured to extract a feature vector of each training sample, the fully connected layer is configured to sort and convert the feature vector obtained by the backbone network layer into a one-dimensional array, each element of the one-dimensional array represents the score of a preset type, and finally the softmax layer is configured to output the preset type with the highest score. For the first branch network, the preset type is a type corresponding to different colors of a game area, such as red, green, etc., and for the second branch network, the preset type is a type corresponding to different layouts of the game area, such as large table type, medium table type, small table type, etc.

At S550, a target loss of the classification model is determined based on the annotated type of each training sample in the training sample set in each iteration.

Here, the annotated type of each training sample includes a first tag value corresponding to the color type and a second tag value corresponding to the layout type. The target loss of the classification model is determined based on each predicted classification result output by the classification model and the corresponding annotated type.

In some embodiments, a first loss corresponding to a first branch network is determined based on a first tag value and a color classification result of each training sample output through the first branch network in each iteration; a second loss corresponding to a second branch network is determined based on a second tag value and a layout classification result of each training sample output through the second branch network in each iteration; and a target loss of a classification model is determined based on the first loss and the second loss.

Therefore, the loss of each of the two branch networks are respectively calculated through the first tag value corresponding to the color type and the second tag value corresponding to the layout type, and then the final optimized target loss of the whole classification model is obtained, so that the classification network with both the background color and the area layout taken into consideration may be trained based on the target loss.

At S560, a trained classification model is obtained when the target loss of the classification model meets a preset convergence condition.

Here, a parameter of the classification model is adjusted based on the target loss until the parameter of the classification model reaches convergence to obtain the trained classification model.

It should be noted that, when the target loss includes the first loss and the second loss, the parameters of corresponding branches of the classification model are adjusted based on the first loss and the second loss respectively.

In the embodiment of the disclosure, the training sample set and the corresponding binary image set are configured to respectively train two branch networks of the classification model, so that the trained classification model may simultaneously identify the color classification result and the layout classification result of the game area, and the identification accuracy is improved.

The foregoing method for identifying the game area type will be described below according to a specific embodiment. However, it should be noted that the specific embodiment is merely for better illustration of the disclosure and is not intended to unduly limit the disclosure.

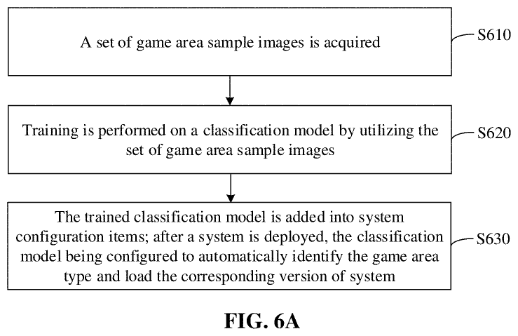

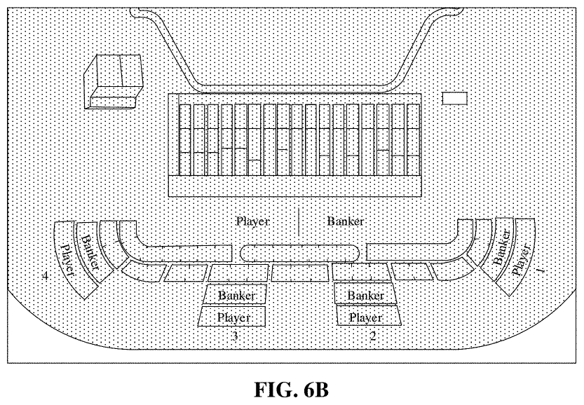

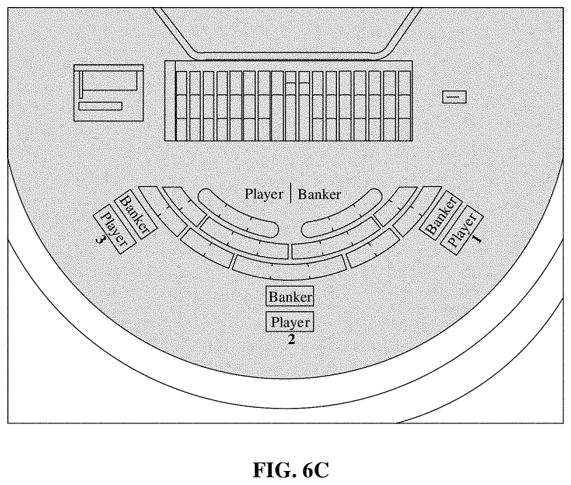

FIG. 6A illustrates a logic flow diagram of a method for identifying a game area type according to an embodiment of the disclosure. As shown in FIG. 6A, the method includes at least the following steps.

At S610, a set of game area sample images is acquired.

Here, as shown in FIG. 6B and 6C, an image from top view of each type of game area in a game scenario is collected to obtain a set of game area sample images, and meanwhile a color type (corresponding to a first tag value) and a layout type (corresponding to a second tag value) of each type of game area are annotated.

Taking the situation that a game area sample image is an image collected for a game table as an example, as shown in FIG. 6B, the background color of a game area is red (filled with the snowy background in the drawing), the first tag value is set as the type corresponding to red, and the lower half of the whole game area includes four sets of areas in which players and bankers arrange game coins, and the second tag value is set as the type corresponding to “medium table type” according to experience. As shown in FIG. 6C, the background color of the game area is gray, and the first tag value is set to be the type corresponding to gray, and the lower half of the whole game area includes three sets of areas in which players and bankers arrange game coins, and the second tag value is set to be the type corresponding to “small table type” according to experience.

At S620, training is performed on a classification model by utilizing the set of game area sample images.

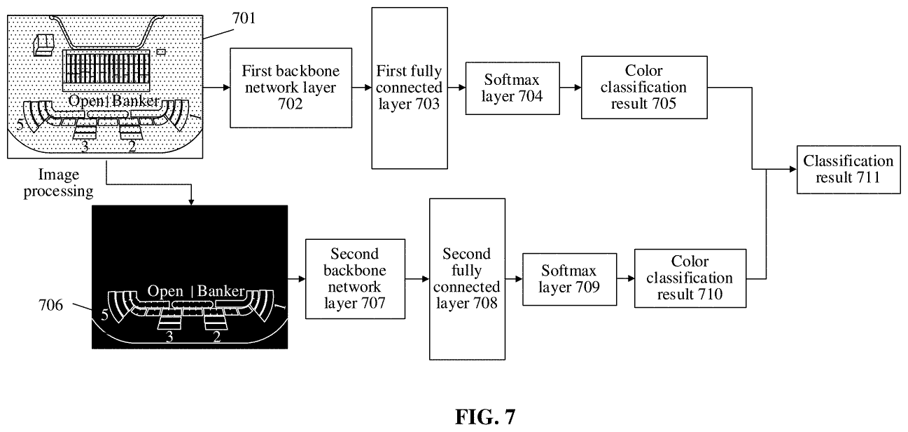

Here, FIG.7 illustrates the training of the classification model, and the classification model 70 includes two branches.

A first branch is trained by utilizing a raw game area sample image 701, and after the raw game area sample image 701 passes through a first backbone network layer 702, a first fully connected (FC) layer 703 and a first softmax layer 704, a color classification result 705 of the game area, such as green, red, beige, gray and etc., is obtained.

A second branch is trained by utilizing a binary image 706 obtained by image processing, in which the color-related background is removed, and information about the layout of the game area is retained, and after the binary image 706 passes through a second backbone network layer 707, a second fully connected layer 708 and a second softmax layer 709, a layout classification result 710 of the game area is obtained.

The first backbone network layer 702 and the second backbone network layer 707 adopt a simple residual network (resnet) structure; and the optimization objective function the classification model 70 adopts a cross entropy loss for optimization.

At S630, the trained classification model is added into system configuration items; after a system is deployed, the classification model being configured to automatically identify the game area type and load the corresponding version of system.

Here, after the system is deployed, the classification model in the system will automatically identify the game area type, which saves the costs of manual verification and system version selection.

It should be noted that the image processing in the above step S520 includes three-step operations: grayscale calculation, binarization and increasing the area of a mask.

In the grayscale calculation, an RGB (Red, Green, Blue) image is converted into a grayscale image. The background colors of game areas in the game scenario are mainly red and green, and grayscale calculation is performed to remove the background, so that the weights of red channel and green channel are correspondingly reduced when grayscale weighting is performed. The calculation formula is: Grayscale value=65/255*red channel+65/255*green channel+125/255*blue channel.

In the binarization operation, based on the calculated grayscale value, if the grayscale value of a certain pixel is greater than 255*0.5, the grayscale value of the corresponding pixel is set to be 255, i.e., white; and if the grayscale value of a certain pixel is less than 255*0.5, the grayscale value of the corresponding pixel is 0, i.e., black.

When the area of the mask is increased, due to the fact that the upper part of the game area sample image has no obvious layout information of the game area, one third of the area of the mask is configured to cover the upper part of the game area sample image.

The mask is configured to mask (all or part of) the processed image with a selected image, figure or object to control the image processing.

Therefore, the training of the classification model according to the embodiment of the disclosure fully takes two factors of the background color and the game area layout of the game area type into consideration, and improves the accuracy of the game area classification.

Traditional manual deployment strategy errors cause waste of resources and costs, while the feature point matching and the simple classification network in the related art have poor robustness, and system deployment failures are prone to being caused by identification errors. The embodiments of the disclosure provide a classification network, which simultaneously takes two factors of background color and layout of the game area into consideration, improves the accuracy of identification, and reduces the costs of manual inspection and identification errors.

The smart game scenario is provided with different game area types and different game rules, and the confirmation and inspection of game area types and the deployment of corresponding versions of systems will consume a lot of labor costs. According to the embodiments of the disclosure, the game area types are automatically identified and classified according to the differences in background color and the layout between game areas, so that the system deployment is more convenient and the costs and resources are saved.

The method for identifying the game area type according to the embodiments of the disclosure may be applied to identifying a game table type in the smart game scenario. In the smart game scenario, a game area image according to any one of the embodiments of the disclosure is a game table image.

Based on the foregoing embodiments, an embodiment of the disclosure further provides an apparatus for identifying a game area type. Each module, each sub-module in each module and each unit of the apparatus may be implemented by a processor in an electronic device. Definitely, each may be further implemented by a specific logic circuit. In the implementation, the processor may be a CPU (Central Processing Unit), MPU (Micro Processing Unit), DSP (Digital Signal Processor) or FPGA (Field Programmable Gate Array), etc.

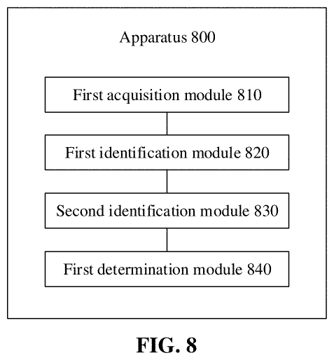

FIG. 8 illustrates a schematic diagram of component structure of an apparatus for identifying a game area type according to an embodiment of the disclosure. As shown in FIG. 8, the apparatus 800 includes a first acquisition module 810, a first identification module 820, a second identification module 830 and a first determination module 840.

The first acquisition module 810 is configured to acquire a first game area image to be identified.

The first identification module 820 is configured to identify the first game area image through a first branch network of a trained classification model to obtain a color classification result of a game area in the first game area image.

The second identification module 830 is configured to identify a second game area image through a second branch network of the trained classification model to obtain a layout classification result of the game area. The second game area image is a binary image obtained by performing image processing on the first game area image.

The first determination module 840 is configured to determine a target type of the game area based on the color classification result and the layout classification result of the game area.

In some possible embodiments, the apparatus further includes a grayscale processing module and a binarization processing module. The grayscale processing module is configured to perform grayscale processing on a first game area image to obtain a grayscale image corresponding to the first game area image; and the binarization processing module is configured to perform binarization processing on the grayscale image based on a grayscale value of each pixel in the grayscale image to obtain a second game area image.

In some possible embodiments, the grayscale processing module includes a first determination sub-module and a second determination sub-module. The first determination sub-module is configured to determine a weight coefficient of each color channel of each pixel in a first game area image based on identification and classification requirement of a game area. The second determination sub-module is configured to determine a grayscale value of each pixel in a grayscale image based on a pixel value of each color channel and the corresponding weight coefficient of each pixel in the first game area image.

In some possible embodiments, the binarization processing module includes a third determination sub-module and a fourth determination sub-module. The third determination sub-module is configured to determine a target pixel value of each pixel by sequentially comparing a grayscale value of each pixel with a specific threshold value, and the target pixel value is a pixel value corresponding to black or white. The fourth determination sub-module is configured to obtain a second game area image based on target pixel values of all pixels in the grayscale image.

In some possible embodiments, the apparatus further includes a second determination module and a mask covering module. The second determination module is configured to determine a target area in a second game area image, and the mask covering module is configured to add a background mask to the target area in the second game area image to obtain a new second game area image.

In some possible embodiments, the apparatus further includes a second acquisition module, a training module, a third determination module and a fourth determination module. The second acquisition module is configured to acquire a training sample set. The training sample set includes at least two training samples, annotated types of which are not exactly the same. The annotated types at least include color types and layout types. The training module is configured to perform iterative training on a classification model by utilizing the training sample set. The third determination module is configured to determine a target loss of the classification model based on the annotated type of each training sample in the training sample set in each iteration. The fourth determination module is configured to obtain a trained classification model when the target loss of the classification model meets a preset convergence condition.

In some possible embodiments, the annotated type of each training sample includes a first tag value corresponding to a color type and a second tag value corresponding to a layout type. The third determination module includes a fifth determination sub-module, a sixth determination sub-module and a seventh determination sub-module. The fifth determination sub-module is configured to determine a first loss corresponding to a first branch network based on the first tag value and a color classification result of each training sample output through the first branch network in each iteration. The sixth determination sub-module is configured to determine a second loss corresponding to a second branch network based on the second tag value and a layout classification result of each training sample output through the second branch network in each iteration. The seventh determination sub-module is configured to determine a target loss of the classification model based on the first loss and the second loss.

In some possible embodiments, the apparatus further includes an image processing module, configured to perform image processing on each training sample in a training sample set to obtain a binary image set. Correspondingly, the training module includes a first training sub-module and a second training sub-module. The first training sub-module is configured to perform iterative training on a first branch network of a classification model by utilizing the training sample set; and the second training sub-module is configured to perform iterative training on a second branch network of the classification model by utilizing the binary image set.

In some possible embodiments, each of first branch network and second branch network includes a backbone network layer, a fully connected layer, and a softmax layer.

It should be noted here that, the description of the foregoing embodiments for the apparatus is similar to the that of the foregoing embodiments for the method, and similar advantages are shared. Technical details which are not disclosed in the embodiments for the apparatus may refer to those of the embodiments for the method for better understanding of the embodiments of the apparatus.

It should be noted that, according to the embodiments of the disclosure, if a method for identifying a game area type is implemented in the form of a software function module and sold or used as an independent product, the method may further be stored in a computer-readable storage medium. Thereon, the technical schemes of the embodiments of the disclosure, or the parts contributing to the related art, may be implemented in the form of a software product. The computer software product is stored in a storage medium and includes instructions for enabling an electronic device (which may be a smart phone with a camera, a tablet computer, etc.) to executes all or part of the method according to the embodiments of the disclosure. The foregoing storage medium may be a medium capable of storing program codes, such as USB flash disk, portable hard drive, ROM (Read Only Memory), diskette or CD. Therefore, the embodiments of the disclosure are not limited to any specific combination of hardware and software.

Correspondingly, an embodiment of the disclosure provides a computer-readable storage medium, in which a computer program is stored. When the computer program is executed by a processor, the steps of a method for identifying a game area type according to any of the foregoing embodiments are implemented. Correspondingly, an embodiment of the disclosure further provides a chip, which includes a programmable logic circuit and/or program instructions. When the chip runs, the chip is configured to implement the steps of a method for identifying a game area type according to any of the foregoing embodiments. Correspondingly, an embodiment of the disclosure further provides a computer program product. When the computer program product is executed by a processor of an electronic device, the computer program product is configured to implemented the steps of a method for identifying a game area type according to any of the foregoing embodiments.

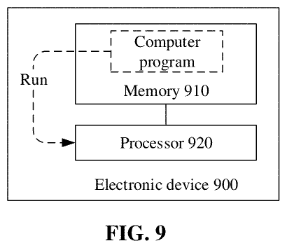

Based on the same technical concept, an embodiment of the disclosure provides an electronic device for implementing a method for identifying a game area type according to the corresponding embodiments. FIG. 9 illustrates a schematic diagram of hardware entities of the electronic device according to the embodiment of the disclosure. As shown in FIG. 9, the electronic device 900 includes a memory 910 and a processor 920, the memory 910 is configured to store a computer program which may be executed by the processor 920, and the processor 920 is configured to execute the program to implement any steps of a method for identifying a game area type according to the embodiments of the disclosure.

The memory 910 is configured to store instructions and applications which may be executed by the processor 920, and may further cache data (for example, image data, audio data, voice communication data, and video communication data) to be processed or already processed by the processor 920 and multiple modules in the electronic device, which may be implemented by a flash memory or RAM (Random Access Memory).

When the processor 920 executes the program, any step of a method for identifying a game area type may be implemented. Generally, the processor 920 is configured to control the overall operation of the electronic device 900.

The processor may be at least one of ASIC (Application Specific Integrated Circuit), DSP (Digital Signal Processor), DSPD (Digital Signal Processing Device), PLD (Programmable Logic Device), FPGA (Field Programmable Gate Array), CPU (Central Processing Unit), a controller, a microcontroller and a microprocessor. It should be understood that the electronic device for implementing the processor functions described above may be another device, which is not specifically limited herein.

The computer storage medium/memory may be ROM (Read Only Memory), PROM (Programmable Read-Only Memory), Erasable Programmable Read-Only Memory (EPROM), EEPROM (Electrically Erasable Programmable Read-Only Memory), FRAM (Ferromagnetic Random Access Memory), flash memory, magnetic platter memory, CD, or CD-ROM (Compact Disc Read-Only Memory), and may further be an electronic device including one or any combination of the above memories such as mobile phone, computer, tablet device, PDA (Personal Digital Assistant), etc.

It should be noted out that, the foregoing descriptions of the embodiments for the storage medium and electronic device are similar to that of the embodiments for the method and similar advantages are shared. Technical details which are not disclosed in the embodiments for the storage medium and electronic device may refer to those of the embodiments for the method for better understanding of the embodiments of the storage medium and electronic device.

It should be understood that, the terms “an embodiment” or “the embodiment” throughout the specification indicate that at least one embodiment includes the specific features, structures or features related to the embodiments of the disclosure. Therefore, the terms “according to an embodiment” or “according to the embodiment” throughout the specification do not necessarily refer to the same embodiment. Further, the specific features, structures or features may be incorporated in any suitable manner to one or more embodiments. It should be understood that, according to the embodiments of the disclosure, the serial numbers of the foregoing processes do not represent the sequence of execution, and the sequence of execution of each process should be determined by the functions and inherent logic thereof, and should not limit the implementation of the embodiments of the disclosure in any way. The foregoing serial numbers of the embodiments of the disclosure are merely for description and do not represent the superiority or inferiority of the embodiments.

It should be noted that, throughout the specification, the terms “including” and “comprising” and any variations thereof are intended be non-exclusive, for example, may denote including a series of elements. A process, method, object, or apparatus are not necessarily limited to the elements explicitly listed, and may include other elements not explicitly listed or inherent to the process, method, object, or apparatus. Unless otherwise defined, an element defined by the term “including an . . . ” does not indicate that a process, method, object or apparatus including the element excludes another same element.

According to the embodiments of the disclosure, it should be understood that the disclosed device and method may be implemented in another way. The foregoing embodiments for the device are merely illustrative, for example, the units are merely classified according to the logical functions thereof, and may be classified in another way in actual application; and for example, multiple units or components may be combined or integrated into another system, or some features may be ignored or not implemented. In addition, the “coupling” or “direct coupling” or “communication connection” shown or discussed herein may be “indirect coupling” or “indirect communication connection” through some communication interfaces, devices or units, which may be implemented in electrical, mechanical or other forms.

The units, illustrated as separate components, may or may not be physically separated, and the components displayed as units may or may not be physical units, i.e., the components may be positioned in one place, or may be distributed over multiple network units. Part or all of the units may be selected according to actual needs to achieve the objectives of the embodiments.

In addition, the functional units according to the embodiments of the disclosure may be integrated in one processing unit, or each unit may exist physically alone, or two or more units may be integrated in one unit. The integrated units may be implemented in the form of software, and may further be implemented in the form of hardware and software functional units.

In some embodiments, the integrated units, if implemented in the form of software functional units and sold or utilized as a product alone, may be stored in a computer-readable storage medium. Thereon, the technical schemes of the embodiments of the disclosure, or the parts contributing to the related art, may be implemented in the form of a software product. The computer software product is stored in a storage medium and includes multiple instructions configured to enable a device automatic test line execute all or part of the steps of a method according to the embodiments of the disclosure. The foregoing storage medium may be a USB, a ROM, a diskette or a CD and another medium capable of storing program codes.

The methods according to the embodiments for method of the disclosure may be combined on a non-conflict basis to obtain new embodiments thereof.

The features disclosed according to the embodiments for method and device of disclosure may be combined on a non-conflict basis to obtain new embodiments thereof.

The foregoing merely illustrates the implementations of the disclosure, but the scope of the disclosure is not limited thereto. Any person skilled in the art may make variations and substitution without departing from the spirit and scope of the disclosure, which should fall within the scope of the disclosure. Therefore, the scope of the disclosure should be defined by the scope of the claims.

What is claimed is:

1. A method for identifying a game area type, comprising:
acquiring a first game area image to be identified;
identifying the first game area image through a first branch network of a trained classification model to obtain a color classification result of a game area in the first game area image;
identifying a second game area image through a second branch network of the trained classification model to obtain a layout classification result of the game area, wherein the second game area image is a binary image obtained by performing image processing on the first game area image; and
determining a target type of the game area based on the color classification result and the layout classification result of the game area.

2. The method of claim 1, wherein the second game area image is obtained by following steps:
performing grayscale processing on the first game area image to obtain a grayscale image corresponding to the first game area image; and
performing binarization processing on the grayscale image based on a grayscale value of each pixel in the grayscale image to obtain the second game area image.

3. The method of claim 2, wherein performing grayscale processing on the first game area image to obtain the grayscale image corresponding to the first game area image comprises:
determining a weight coefficient of each color channel of each pixel in the first game area image based on identification and classification requirement of the game area; and
determining the grayscale value of the each pixel in the grayscale image based on a pixel value and a corresponding weight coefficient of the each color channel of the each pixel in the first game area image.

4. The method of claim 2, wherein performing binarization processing on the grayscale image based on the grayscale value of each pixel in the grayscale image to obtain the second game area image comprises:
determining a target pixel value of the each pixel by sequentially comparing the grayscale value of the each pixel with a specific threshold value, wherein the target pixel value is a pixel value corresponding to black or white; and
obtaining the second game area image based on target pixel values of all pixels in the grayscale image.

5. The method of claim 2, further comprising:
determining a target area in the second game area image; and
adding a background mask to the target area in the second game area image to obtain a new second game area image.

6. The method of claim 1, wherein the classification model is trained by following steps:
acquiring a training sample set, wherein the training sample set comprises at least two training samples, annotated types of which are not exactly the same, wherein the annotated types at least comprise color types and layout types;
performing iterative training on the classification model by utilizing the training sample set;
determining a target loss of the classification model based on the annotated type of each training sample in the training sample set in each iteration; and
obtaining a trained classification model in a case where the target loss of the classification model meets a preset convergence condition.

7. The method of claim 6, wherein the annotated type of each training sample comprises a first tag value corresponding to the color type and a second tag value corresponding to the layout type, wherein determining the target loss of the classification model based on the annotated type of the each training sample in the training sample set in each iteration comprises:
determining a first loss corresponding to the first branch network based on the first tag value and the color classification result of each training sample output through the first branch network in each iteration;
determining a second loss corresponding to the second branch network based on the second tag value and the layout classification result of each training sample output through the second branch network in each iteration; and
determining the target loss of the classification model based on the first loss and the second loss.

8. The method of claim 6, further comprising:
performing image processing on the each training sample in the training sample set to obtain a binary image set;
wherein performing iterative training on the classification model by utilizing the training sample set comprises:
performing iterative training on the first branch network of the classification model by utilizing the training sample set; and
performing iterative training on the second branch network of the classification model by utilizing the binary image set.

9. The method of claim 1, wherein each of the first branch network and the second branch network comprises a backbone network layer, a fully connected layer, and a softmax layer.

10. An electronic device, comprising a memory and a processor, wherein the memory is configured to store a computer program executable by the processor, wherein when executing the computer program stored in the memory, the processor is configured to:
acquire a first game area image to be identified;
identify the first game area image through a first branch network of a trained classification model to obtain a color classification result of a game area in the first game area image;
identify a second game area image through a second branch network of the trained classification model to obtain a layout classification result of the game area, wherein the second game area image is a binary image obtained by performing image processing on the first game area image; and
determine a target type of the game area based on the color classification result and the layout classification result of the game area.

11. The electronic device of claim 10, wherein the second game area image is obtained by following steps:
performing grayscale processing on the first game area image to obtain a grayscale image corresponding to the first game area image; and
performing binarization processing on the grayscale image based on a grayscale value of each pixel in the grayscale image to obtain the second game area image.

12. The electronic device of claim 11, wherein the processor is specifically configured to:
determine a weight coefficient of each color channel of each pixel in the first game area image based on identification and classification requirement of the game area; and
determine the grayscale value of the each pixel in the grayscale image based on a pixel value and a corresponding weight coefficient of the each color channel of the each pixel in the first game area image.

13. The electronic device of claim 11, wherein the processor is specifically configured to:
determine a target pixel value of the each pixel by sequentially comparing the grayscale value of the each pixel with a specific threshold value, wherein the target pixel value is a pixel value corresponding to black or white; and
obtain the second game area image based on target pixel values of all pixels in the grayscale image.

14. The electronic device of claim 11, wherein the processor is further configured to:
determine a target area in the second game area image; and
add a background mask to the target area in the second game area image to obtain a new second game area image.

15. The electronic device of claim 10, wherein the classification model is trained by following steps:
acquiring a training sample set, wherein the training sample set comprises at least two training samples, annotated types of which are not exactly the same, wherein the annotated types at least comprise color types and layout types;
performing iterative training on the classification model by utilizing the training sample set;
determining a target loss of the classification model based on the annotated type of each training sample in the training sample set in each iteration; and
obtaining a trained classification model in a case where the target loss of the classification model meets a preset convergence condition.

16. The electronic device of claim 15, wherein the annotated type of each training sample comprises a first tag value corresponding to the color type and a second tag value corresponding to the layout type,
wherein the processor is specifically configured to:
determine a first loss corresponding to the first branch network based on the first tag value and the color classification result of each training sample output through the first branch network in each iteration;
determine a second loss corresponding to the second branch network based on the second tag value and the layout classification result of each training sample output through the second branch network in each iteration; and
determine the target loss of the classification model based on the first loss and the second loss.

17. The electronic device of claim 15, wherein the processor is further configured to:
perform image processing on the each training sample in the training sample set to obtain a binary image set;
wherein the processor is specifically configured to:
perform iterative training on the first branch network of the classification model by utilizing the training sample set; and
perform iterative training on the second branch network of the classification model by utilizing the binary image set.

18. The electronic device of claim 10, wherein each of the first branch network and the second branch network comprises a backbone network layer, a fully connected layer, and a softmax layer.

19. A non-volatile computer-readable storage medium, wherein the non-volatile computer-readable storage medium is configured to store a computer program, and the computer program is executed by a processor to:
acquire a first game area image to be identified;
identify the first game area image through a first branch network of a trained classification model to obtain a color classification result of a game area in the first game area image;
identify a second game area image through a second branch network of the trained classification model to obtain a layout classification result of the game area, wherein the second game area image is a binary image obtained by performing image processing on the first game area image; and
determine a target type of the game area based on the color classification result and the layout classification result of the game area.

20. The non-volatile computer-readable storage medium of claim 19, wherein the second game area image is obtained by following steps:
performing grayscale processing on the first game area image to obtain a grayscale image corresponding to the first game area image; and
performing binarization processing on the grayscale image based on a grayscale value of each pixel in the grayscale image to obtain the second game area image.
